(19) United States
(12) Patent Application Publication
(10) Pub. No.: US 2013/0287887 A1
(43) Pub. Date: Oct. 31, 2013

(54) Valve-Stem Assembly Removable from Runner System While Valve-Actuator Assembly Remains Connected with Manifold Assembly

(71) Applicants: William Steven Keir, Aurora (CA); Darrin Albert MacLeod, Jeffersonville, VT (US)

(72) Inventors: William Steven Keir, Aurora (CA); Darrin Albert MacLeod, Jeffersonville, VT (US)

(73) Assignee: HUSKY INJECTION MOLDING SYSTEMS LTD., Bolton, ON (CA)

(21) Appl. No.: 13/997,710

(22) PCT Filed: Jan. 17, 2012
(86) PCT No.: PCT/US12/21490

§ 371 Date: Jun. 25, 2013

Related U.S. Application Data
(60) Provisional application No. 61/436,338, filed on Jan. 26, 2011.

(51) Int. Cl. B29C 45/23

(52) U.S. Cl. CPC B29C 45/23
USPC 425/562

(57) ABSTRACT

A mold-tool system (100), comprising: a valve-stem assembly (102) being configured to be: (i) intractable with a valve-actuator assembly (202) while the valve-actuator assembly (202) remains connected with a manifold assembly (614), the manifold assembly (614) being supported by a runner system (600) of a molding system (200); and (ii) removable from the runner system (600) while the valve-actuator assembly (610) remains connected with the manifold assembly (614) inside the runner system (600).

### TECHNICAL FIELD

An aspect generally relates to (but is not limited to): a mold-tool system including (and not limited to: a valve-stem assembly configured to be: removable from a runner system while valve-actuator assembly remains connected with the manifold assembly.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public.

Valve stems are currently a wear item and may require splitting of hot runner plates to change out worn parts. This may be a lengthy process and may not be practical to perform at all customer sites. These parts are also costly. In addition to wear issues, various gate diameters and stem tip profiles may not be routinely required to manufacture different performs (that is, molded articles). With the current design may be once again time consuming and costly. One of the biggest challenges may be optimizing the injection process parameters to achieve ideal part quality and cycle times. Often stem tip temperature may be critical in ensuring good part quality. This may be largely achieved by altering stem open and close times to heat up or cool down the stem tip, limiting the flexibility of the operator by having one variable to work with, or worse, altering temperature to achieve perform quality while increasing cycle time.

According to one aspect, there is provided (to be a solution to the problem identified above, at least in part) a mold-tool system (100), comprising: a valve-stem assembly (102) being configured to be: (i) intractable with a valve-actuator assembly (202) while the valve-actuator assembly (202) remains connected with a manifold assembly (614), the manifold assembly (614) being supported by a runner system (600) of a molding system (200); and (ii) removable from the runner system (600) while the valve-actuator assembly (610) remains connected with the manifold assembly (614) inside the runner system (600).

The following advantages may be realized for the above described solution: (1) If a method of replacing stem tips is introduced from the interface of the cavity assembly of the mold assembly, it may be possible to quickly and efficiently perform stem changes at the customer sight with little down time and avoid what is now a major undertaking and usually involves sending the hot runner out for refurbishment. This may add significant value to the customer. For certain applications with a short service life, alternate materials may be used to increase service intervals. (2) It may also be a requirement for many customers to swap out various molds and cavities with a hot-runner assembly. The ability to change valve stem diameters and/or stem profile (such as tapered and/or straight) may be added value to many customers who may benefit from further tooling compatibility. (3) One of the biggest challenges may be optimizing the injection process parameters to achieve ideal part quality and cycle times. Often stem tip temperature may be critical in ensuring good part quality. By enabling customers to swap out stem tips of various materials that give thermal benefits either that heat up quicker or slower, this may give customers an additional variable to is achieve optimum part quality and cycle time. For example, a more conductive stem tip may heat quicker in the melt, and/or cool quicker at the gate, conversely, with a less conductive tip. Combining this with valve stem open/close timing may further refine the optimization process. The solution helps to facilitate changing out of vale stem tips from the cavity Interface, allowing improved access and may greatly reduce down time compared to the known systems as well as enabling “on the fly” changes versus refurbishment. With the solution provided above, the cavity plate (also called the cavity assembly) may be latched over, the old stem tips may be removed, and new stem tips are installed in one to two hours, for example.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

The following FIGS. depict various structures for selective attachment and detachment that may be employed to permit quick change out of the valve stem. Heating and cooling of parts prior to assembly using dry ice or tooling using threads may aid in installation or removal of the valve stem. Several approaches are described below to break or deform the replacement part and leave the piston or a valve body intact.

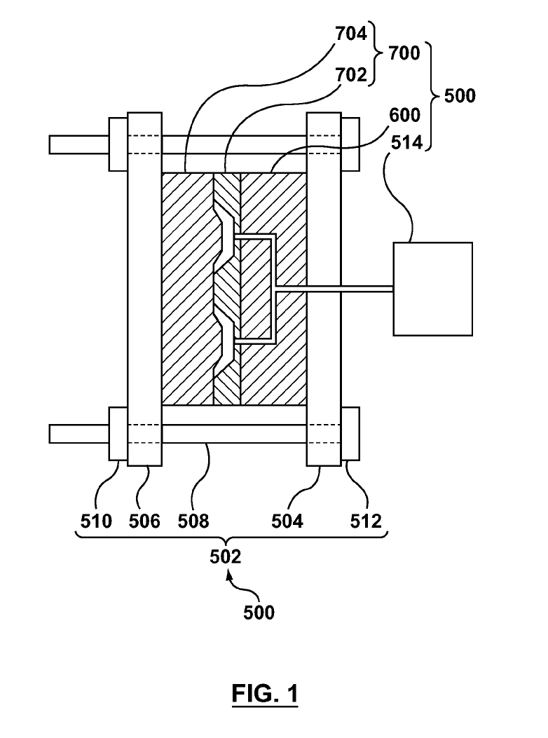

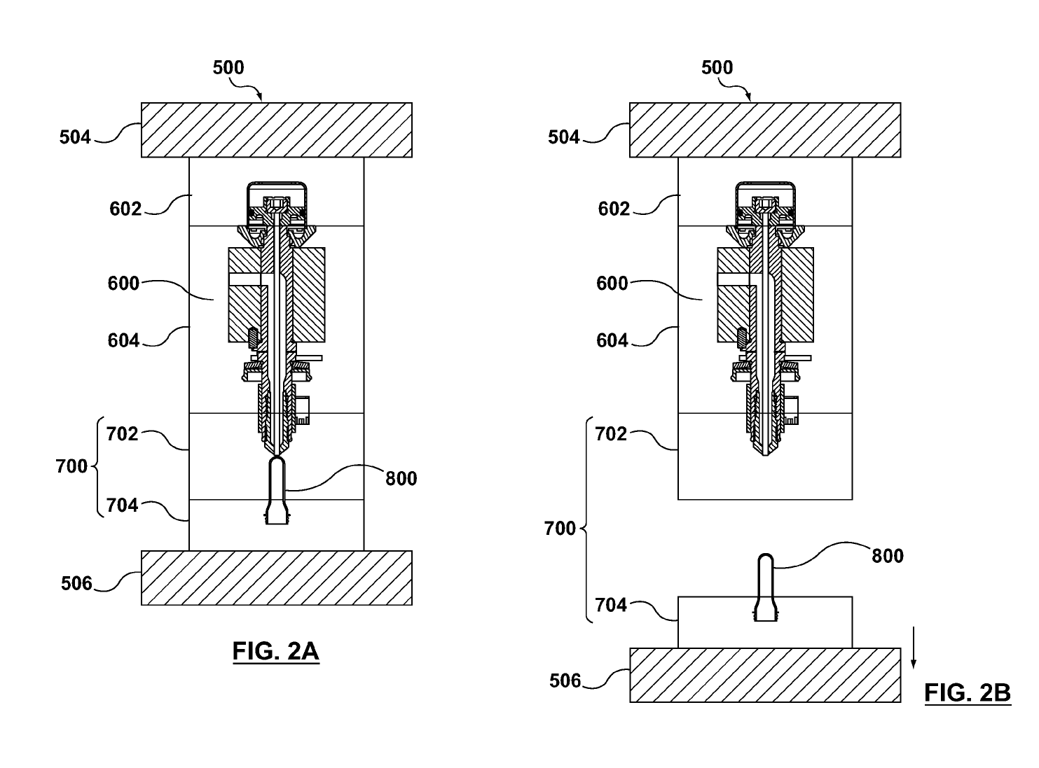

FIGS. 1, 2A, 2B depict schematic representations of an example of a molding system (500), a mold assembly (700), and a runner system (600);

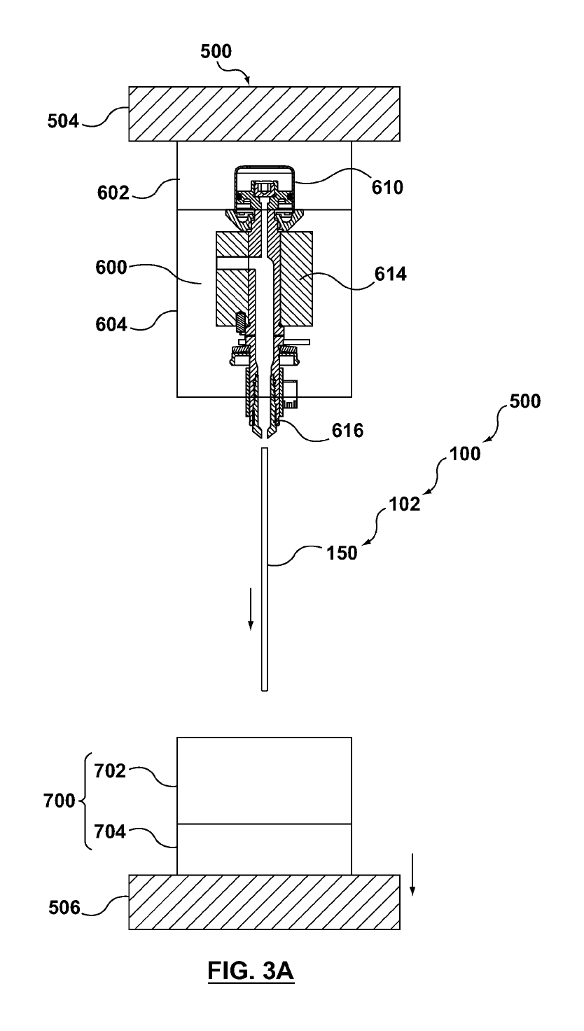

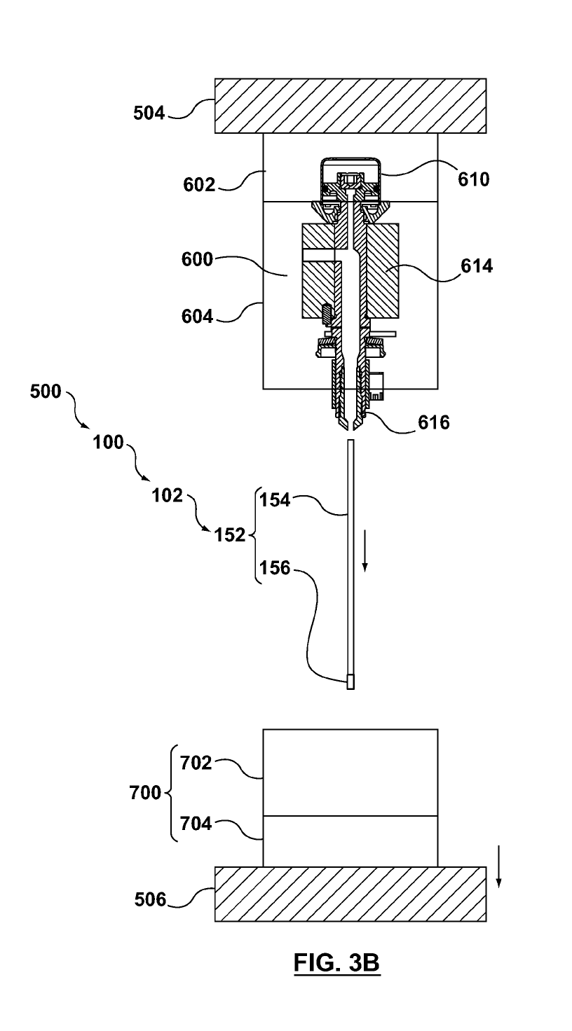

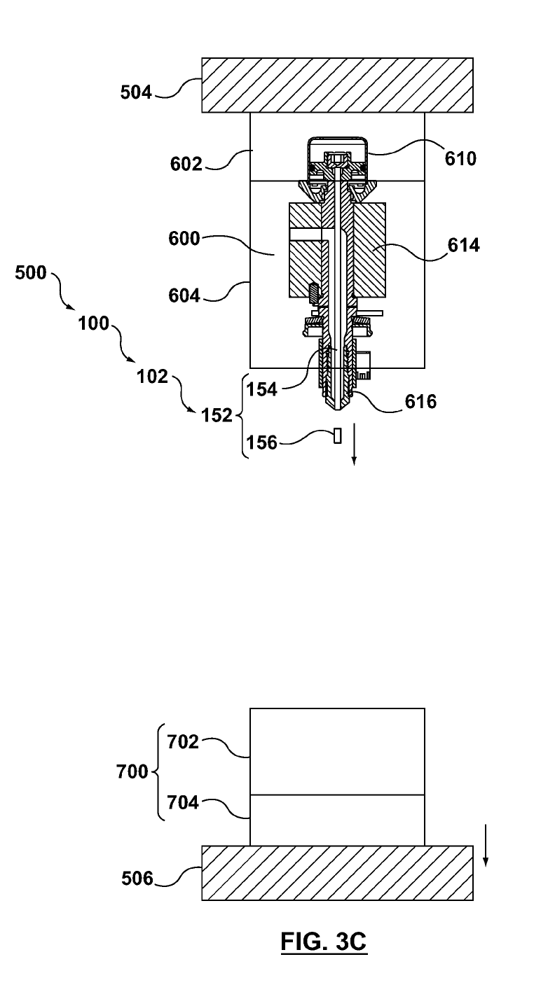

FIGS. 3A, 3B, 3C, 4B, 5A, 5B, 5C, 6A, 6B depict schematic representations of examples of a mold-tool system (100); and

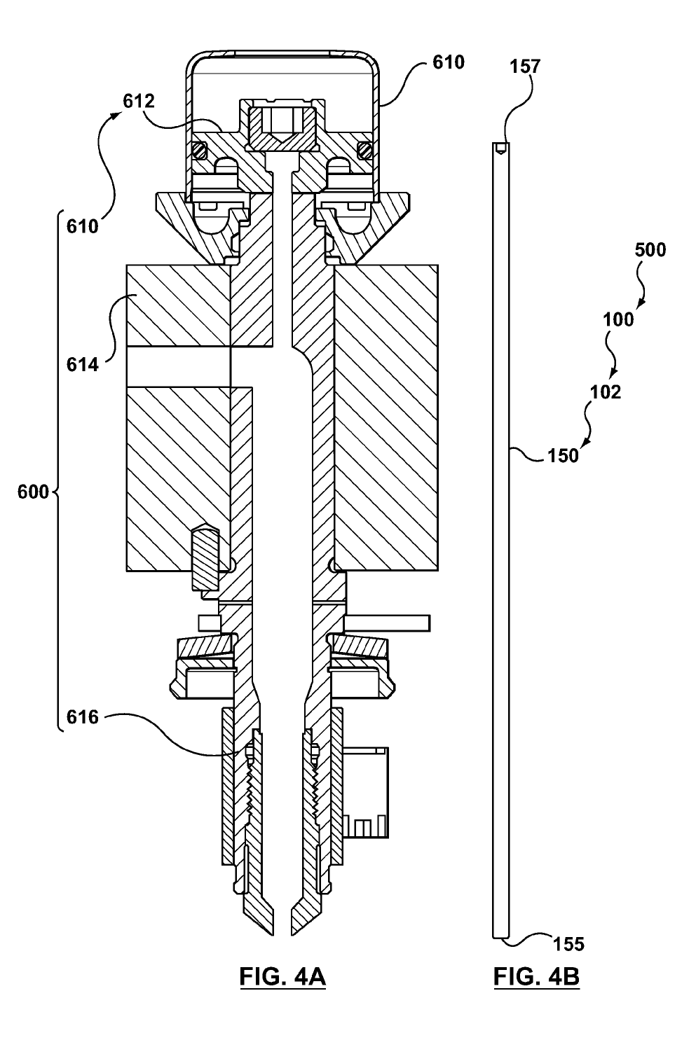

FIG. 4A depicts another schematic representation of another example of the runner system (600).

The drawings are not necessarily to scale and may be illustrated by phantom lines, is diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1, 2A, 2B depict the schematic representations of an example of the molding system (500), the mold assembly (700), and the runner system (600). FIGS. 3A, 3B, 3C, 4B, 5A, 5B, 5C, 6A, 6B depict the schematic representations of the examples of the mold-tool system (100). FIG. 4A depicts the schematic representation of an example of the runner system (600). The molding system (500) may have or include the mold-tool system (100). The runner system (600) may have or include the mold-tool system (100). The mold assembly (700), the runner system (600), the molding system (500) and the mold-tool system (100) may be supplied by the same vendor or may be supplied by different vendors. The mold assembly (700), the runner system (600), the molding system (200) and the mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

Referring now to FIG. 1, there is depicted an example of the molding system (500). The molding system (500) may include (and is not limited to): a clamp assembly (502), and a melt-preparation assembly (514). The mold assembly (700) is held in position by the clamp assembly (502). The clamp assembly (502) may include (and is not limited to): a stationary platen (504), a movable platen (506), a rod assembly (508), a lock assembly (510), a clamp unit (512). The movable platen (506) is configured to be movable (by way of a platen-moving actuator) relative to the movable platen (506). The rod assembly (508), which may include rods for each respective corner of the stationary platen (504) and the movable platen (506), extends between the stationary platen (504) and the movable platen (506). The lock assembly (510) may be used to lock the position of the stationary platen (504) relative to the movable platen (506). The clamp unit (512) may include clamps at respective corners of the stationary platen (504). The melt-preparation assembly (514) is configured to receive and convert, in use, a resin or suitable moldable material into a flowable resin or a flowable molding material. The melt-preparation assembly (514) conveys the flowable molding material (under pressure) to the runner system (600). For the case where the mold assembly (700) is shut and the clamp unit (512) is actuated to apply a pressure to the mold assembly (700), the runner system (600) may then distribute, in use, the flowbale molding material to the mold assembly (700), which may be used to mold one or more molded articles. The mold assembly (700) may include (and is not limited to): a cavity assembly (702) and a core assembly (704). The cavity assembly (702) is supported by the stationary platen (504). The core assembly (704) is supported by the movable platen (506). The core assembly (704) is movable relative to the cavity assembly (702).

Referring now to FIG. 2A, the molding system (500) is depicted in a molding operation, in which the mold assembly (700) is being maintained shut and the cavity assembly (702) abuts the core assembly (704) so that the mold assembly (700) may mold a molded article (800).

Referring now to FIG. 2B, the molding system (500) is depicted in article-removal operation, in which the mold assembly (700) is opened so that the core assembly (704) is moved away from the cavity assembly (702), and in this case, the core assembly (704) is set apart from the cavity assembly (702). Now the molded article (800) may be removed from the mold assembly (700).

Referring now to FIG. 3A, a schematic representation depicts an example of the mold-tool system (100). The definition of the mold-tool system (100) is as follows: a system that may be positioned and/or may be used in an envelope defined by a platen system of the molding system (500), such as an injection-molding system for example. The platen system may include the stationary platen (504) and the movable platen (506) that is moveable relative to the stationary platen (504). Examples of the mold-tool system (100) may include (and is not limited to): a runner system (600), such as a hot-runner system or a cold-runner system, a nozzle assembly (616), a manifold assembly (614), and/or any sub-assembly or part thereof.

More specifically, the mold-tool system (100) may include (and is not limited to): a valve-stem assembly (102).The valve-stem assembly (102) may be configured to be: intractable with a valve-actuator assembly (610), which is more fully depicted in FIG. 4A, while the valve-actuator assembly (610) remains connected with a manifold assembly (614). The manifold assembly (614) may be supported by the runner system (600) of the molding system (200). The valve-stem assembly (102) may also be configured to be: removable from the runner system (600) while the valve-actuator assembly (610) remains connected with the manifold assembly (614) inside the runner system (600). The valve-stem assembly (102) may be further configured to be removable from the valve-actuator assembly (610) from a mold side (207) of the runner system (600) while the valve-actuator assembly (610) remains connected with the manifold assembly (614).

The runner system (600) may include (and is not limited to): a backing plate (602), a manifold plate (604). The backing plate (602) may be configured for connection with the stationary platen (504) of the clamp assembly (502) of the molding system (500). The manifold plate (604) may be connected with the backing plate (602). The manifold assembly (614) may be supported by the manifold plate (604). A nozzle assembly (616), which is depicted more clearly in FIG. 4A, may be connected with the manifold assembly (614). The nozzle assembly (616) may be configured to receive the valve-stem assembly (102). The nozzle assembly (616) may be configured to fluidly communicate with the mold assembly (700).

The mode of operation depicted in FIGS. 3A, 3B, 3C is the stem-replacement operation, in which the cavity assembly (702) may be disconnected from and movable relative to the manifold plate (604) between: (i) abutment with the manifold plate (604), and (ii) a position being set apart from the manifold plate (604). The cavity assembly (702) may remain connected with the core assembly (704) during the stem-replacement operation while the stationary platen (504) is moved away from the stationary platen (504), so as to facilitate remove of the valve-stem assembly (102) from the runner system (600).

The stem-replacement operation may include a stem-removal operation in which while the cavity assembly (702) of the mold assembly (700) is positioned set apart from the manifold plate (604), the valve-stem assembly (102) may be separated from the valve-actuator assembly (610) while the valve-actuator assembly (610) remains connected with a manifold assembly (614).

The stem-replacement operation may include a stem-insertion operation in which while the cavity assembly (702) of the mold assembly (700) is set apart from the manifold plate (604), the valve-stem assembly (102)—that is, a new valve-stem assembly (102)—may be connected to the valve-actuator assembly (610) while the valve-actuator assembly (610) remains connected with the manifold assembly (614).

The specific example provided by FIG. 3A depicts the valve-stem assembly (102) having or including a one-piece stem (150). Other examples are depicted in FIGS, 3B and 3C.

Referring now to FIG. 3B, a schematic representation depicts another example of the mold-tool system (100). For the example depicted in FIG. 3B, the two-piece stem (152) is removed form the runner system (600). For FIGS. 3A, 3B, the valve-stem assembly (102) may include (and is not limited to): a stem shaft (154), and a separable stem tip (156). The separable stem tip (156) may be configured for selective connection and disconnection with the stem shaft (154).

According to a first option, the separable stem tip (156) may be configured for selective connection and disconnection with the stem shaft (154), and the separable stem tip (156) has a diameter that may be different from the diameter of the stem shaft (154).

According to a second option, the separable stem tip (156) may be configured for selective connection and disconnection with the stem shaft (154), and the separable stem tip (156) may have a tip geometry that may be different from a geometry of the stem shaft (154). For example, the tip geometry may include (and is not limited to): different tip geometry configured for pressure relief, tapered, and/or round, etc.

According to a third option, the separable stem tip (156) may be configured for selective connection and disconnection with the stem shaft (154), and the separable stem tip (156) may have a thermal conductivity that may be different from the thermal conductivity of the stem shaft (154).

According to a fourth option, the separable stem tip (156) may be configured for selective connection and disconnection with the stem shaft (154), and the separable stem tip (156) may have a physical property that may be different from the physical property of the stem shaft (154), such as, and not limited to: hardness, etc.

According to a fifth option, the stem shaft (154) may be selectively connectable and disconnectable with the valve-actuator assembly (610), and the separable stem tip (156) may be configured for selective connection and disconnection with a stem shaft (154).

For the example depicted in FIG. 3C, the separable stem tip (156) is removed form the runner system (600), specifically removed from the stem shaft (154) of the two-piece stem (152) while the stem shaft (154) remains in the runner system (600).

Referring to FIG. 4A, a more detailed depiction of the runner system (600) is provided. The valve-actuator assembly (610) may include (and is not limited to): a piston assembly (612). The valve-actuator assembly (610) may be connected or attached to the manifold assembly (614). The nozzle assembly (616) may be connected or attached to the manifold assembly (614).

Referring to FIG. 4B, there is depicted an example of the one-piece stem (150) that may be selectively connectable and disconnectable with the valve-actuator assembly (610), and an integral stem tip (155) may be integral with the one-piece stem (150). The one-piece stem (150) may also include an actuator-facing portion (157) that faces the valve-actuator assembly (610).

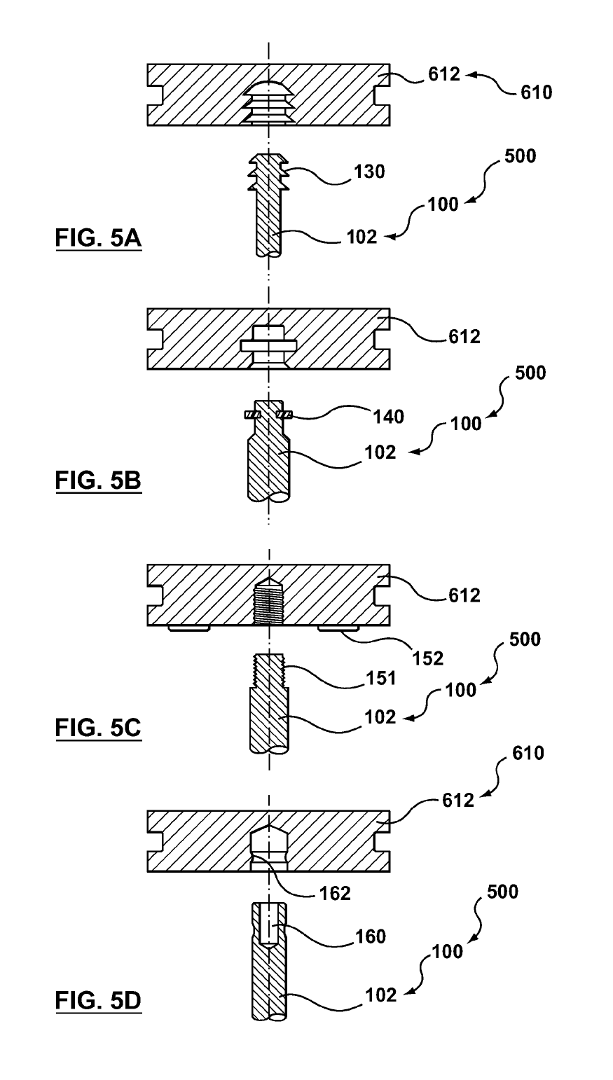

Referring now to FIG. 5A, an example of the valve-actuator assembly (610) is depicted, in which the valve-actuator assembly (610) may include (and is not limited to): a break-tab structure (130) that may be configured to permit the valve-stem assembly (102) to break away from the valve-actuator assembly (610) in response to a calculated load applied to the valve-stem assembly (102).

Referring now to FIG. 5B, another example depicts the valve-actuator assembly (610) that may include (and is not limited to): a spring-retaining ring structure (140) that may be configured to permit the valve-stem assembly (102) to break away from the valve-actuator assembly (610) in response to a calculated load applied to the valve-stem assembly (102).

Referring to FIG. 5C, yet another example depicts the valve-actuator assembly (610) that may include (and is not limited to): a thread structure (151) that may configured to threadably connect the valve-stem assembly (102) to the valve-actuator assembly (610).

Referring to FIG. 5D, yet again another example depicts the valve-actuator assembly (610) that may include (and is not limited to): the valve-stem assembly (102) that may include a deformable end (160), and the valve-actuator assembly (610) includes a detent spring structure (162) that may be configured to be attachably detachable to the deformable end (160) of the valve-stem assembly (102).

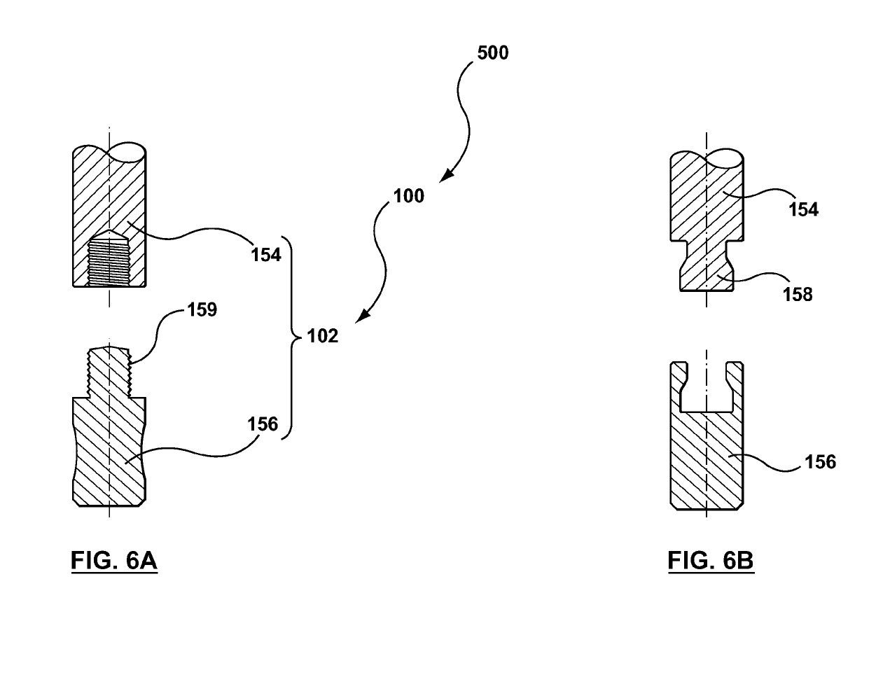

Referring now to FIG. 6A, an example is depicted in which the separable stem tip (156) may be configured to be press fitted to a stem shaft (112) of the valve-stem assembly (102).

Referring now to FIG. 6B, another example is depicted in which the separable stem tip (156) may be configured to be threadably connected to a stem shaft (112) of the valve-stem assembly (102).

There may be several reasons for changing out the valve stems, such as: (i) it may be required to use different tip diameters, (ii) it may be required to use different tip geometry for pressure relief, tapered, or round, etc, and/or (iii) different stem tip(s) or stem materials may be required, such as higher or lower thermal conductivity, higher or lower hardness, etc.

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a valve-stem assembly (102) being configured to be:
(i) intractable with a valve-actuator assembly (202) while the valve-actuator assembly (202) remains connected with a manifold assembly (614), the manifold assembly (614) being supported by a runner system (600) of a molding system (200); and
(ii) removable from the runner system (600) while the valve-actuator assembly (610) remains connected with the manifold assembly (614) inside the runner system (600).

2. The mold-tool system (100) of claim 1, wherein:
the valve-stem assembly (102) is further configured to be removable from the valve-actuator assembly (202) from a mold side (207) of the runner system (600) while the valve-actuator assembly (610) remains connected with the manifold assembly (614).

3. The mold-tool system (100) of claim 1, wherein:
while a cavity assembly (702) of a mold assembly (700) is set apart from a manifold plate (604), the valve-stem assembly (102) may be connected to the valve-actuator assembly (610) while the valve-actuator assembly (610) remains connected with the manifold assembly (614).

4. The mold-tool system (100) of claim 1, wherein:
while a cavity assembly (702) of a mold assembly (700) is positioned set apart from a manifold plate (604), the valve-stem assembly (102) may be separated from the valve-actuator assembly (610) while the valve-actuator assembly (610) remains connected with the manifold assembly (614).

5. The mold-tool system (100) of claim 1, wherein:
the valve-stem assembly (102) includes:
a one-piece stem (150) being selectively connectable and disconnectable with the valve-actuator assembly (610); and
an integral stem tip (155) being integral with the one-piece stem (150).

6. The mold-tool system (100) of claim 1, wherein:
the valve-stem assembly (102) includes:
a stem shaft (154); and
a separable stem tip (156) being configured for selective connection and disconnection with the stem shaft (154).

7. The mold-tool system (100) of claim 1, wherein:
the valve-stem assembly (102) includes:
a stem shaft (154); and
a separable stem tip (156) being configured for selective connection and disconnection with the stem shaft (154), the separable stem tip (156) having a diameter being different from the diameter of the stem shaft (154).

8. The mold-tool system (100) of claim 1, wherein:
the valve-stem assembly (102) includes:
a stem shaft (154); and
a separable stem tip (156) being configured for selective connection and disconnection with the stem shaft (154), the separable stem tip (156) having a tip geometry being different from a geometry of the stem shaft (154).

9. The mold-tool system (100) of claim 1, wherein:
the valve-stem assembly (102) includes:
a stem shaft (154); and
a separable stem tip (156) being configured for selective connection and disconnection with the stem shaft (154), the separable stem tip (156) having a thermal conductivity being different from the thermal conductivity of the stem shaft (154).

10. The mold-tool system (100) of claim 1, wherein:
the valve-stem assembly (102) includes:
a stem shaft (154); and
a separable stem tip (156) being configured for selective connection and disconnection with the stem shaft (154), the separable stem tip (156) having a physical property being different from the physical property of the stem shaft (154)

11. The mold-tool system (100) of claim 1, wherein:
the valve-stem assembly (102) includes:
a stem shaft (154) being selectively connectable and disconnectable with the valve-actuator assembly (610); and
a separable stem tip (156) being configured for selective connection and disconnection with the stem shaft (154).

12. The mold-tool system (100) of claim 1, wherein:
the valve-stem assembly (102) includes:
a separable stem tip (156) being configured for selective connection and disconnection with a stem shaft (154), the separable stem tip (156) having a tip geometry being different from a geometry of the stem shaft (154).

13. The mold-tool system (100) of claim 1, wherein:
the valve-stem assembly (102) includes:
a separable stem tip (156) being configured to be threadably connected to a stem shaft (112) of the valve-stem assembly (102).

14. The mold-tool system (100) of claim 1, wherein:
the valve-stem assembly (102) includes:
a separable stem tip (156) being configured to be press fitted to a stem shaft (112) of the valve-stem assembly (102).

15. The mold-tool system (100) of claim 1, wherein:
the valve-actuator assembly (610) includes:
a break-tab structure (130) being configured to permit the valve-stem assembly (102) to break away from the valve-actuator assembly (610) in response to a calculated load applied to the valve-stem assembly (102).

16. The mold-tool system (100) of claim 1, wherein:
the valve-actuator assembly (610) includes:
a spring-retaining ring structure (140) being configured to permit the valve-stem assembly (102) to break away from the valve-actuator assembly (610) in response to a calculated load applied to the valve-stem assembly (102).

17. The mold-tool system (100) of claim 1, wherein:
the valve-actuator assembly (610) includes:
a thread structure (151) being configured to threadably connect the valve-stem assembly (102) to the valve-actuator assembly (610).

18. The mold-tool system (100) of claim 1, wherein:
the valve-stem assembly (102) includes a deformable end (160); and
the valve-actuator assembly (610) includes a detent spring structure (162) being configured to be attachably detachable to the deformable end (160) of the valve-stem assembly (102).

19. A mold-tool system (100), comprising:
a runner system (600);
a manifold assembly (614) being supported by the runner system (600);
a valve-actuator assembly (202) being connected with the manifold assembly (614); and
a valve-stem assembly (102) being configured to be:
(i) intractable with the valve-actuator assembly (202) while the valve-actuator assembly (202) remains connected with the manifold assembly (614); and
(ii) removable from the runner system (600) while the valve-actuator assembly (610) remains connected with the manifold assembly (614).

20. A molding system (500) having the mold-tool system (100) of any preceding claim.

21. A runner system (600) having the mold-tool system (100) of any preceding claim.
